(19) United States
(12) Patent Application Publication
(10) Pub. No.: US 2019/0154339 A1
(43) Pub. Date: May 23, 2019

(54) Sterile Apparatus for Rapid Cooling of Hot Water

(71) Applicants: Reut Rosenblum, Petah Tikva (IL); Yedidya Yochai Van Dijk, Yekir (IL)

(72) Inventors: Reut Rosenblum, Petah Tikva (IL); Yedidya Yochai Van Dijk, Yekir (IL)

(21) Appl. No.: 16/252,603

(22) Filed: Jan. 19, 2019

Related U.S. Application Data
(63) Continuation-in-part of application No. 15/505,651, filed on Feb. 22, 2017.

(30) Foreign Application Priority Data
May 10, 2015 (IL) 238731

(51) Int. Cl. F28D 1/02; A47G 19/12; F25D 3/08; F28D 1/053; F28D 7/16; F28F 9/00

(52) U.S. Cl. CPC F28D 1/0213; A47G 19/127; F25D 3/08; F28D 1/0535; F28D 2021/0042; F28F 9/001; F25D 2303/08221; F25D 2303/0842; F28D 7/1684

(57) ABSTRACT

An apparatus for cooling liquids that includes a tank that has two longitudinal walls, two lateral walls and a top opening, and cooling flasks that each of has two longitudinal walls and two lateral walls. The cooling flasks are designed to be fixed inside the tank by attaching their lateral walls to the recesses that are match to each other. The cooling flasks are designed to be set within the tank in such a way that a gap smaller than 2.5 millimeters is formed between each two adjacent cooling flasks, creating a cooling space. The volume of the cooling flasks is three times greater or more than the volume of the cooling space. A user can pour hot water into the cooling space and a coolant material within the cooling flasks adsorbs heat from the hot water.

### RELATED APPLICATIONS

This application is a continuation in part of U.S. patent application Ser. No. 15/505,651 filed on Feb. 22, 2017 which is a National Phase of PCT patent application number PCT/IL2016/050446 having International filing date of 1 May 2016, which claims the benefit of priority of IL patent application number 238731 filed on 10 May 2015. The contents of the above applications are all incorporated by reference as if fully set forth herein in their entirety.

### TECHNICAL FIELD

The present invention refers to a sterile apparatus for the rapid cooling of hot water.

### BACKGROUND ART

It is often necessary to boil liquids before using them in order to prevent contamination, and then cool them down to a temperature that is suitable for drinking. For example, when preparing milk substitutes for babies, the water must first be boiled in order to prevent contamination, and then cooled down to a temperature that is suitable for feeding the baby. It is of course desirable that the procedure of cooling the water to the desired temperature be sterile. In general, it is commonly accepted that the parent pours the boiling water into the feeding bottle, and waits a relatively long time for the contents to cool. Sometimes the parent places the feeding bottle with the boiled water in a vessel that is filled with tap water, in order to hasten the cooling, although this still requires a long period of time to cool the contents. The present invention offers a good and effective solution to the aforementioned problem, and for a variety of other cases in which there is a need for the rapid, sterile cooling of very hot liquids.

U.S. patent application 2012/0312521 (“Application 521”) discloses a beverage cooling device comprising relatively many parts including several cooling portions, which assembled one into the other. The structure of the device of Application 521 is cumbersome, expensive for manufacturing and not easy for cleaning, relatively to the apparatus subject matter of the present invention.

### DESCRIPTION OF THE DRAWINGS

The intention of the drawing attached to the application is not to limit the scope of the invention and its application. The drawing is intended only to illustrate the invention and it constitutes only one of its many possible implementations.

FIG. 1 depicts the cooling apparatus (1) in its closed state, ready for use.

FIG. 2 presents an exploded view of the apparatus (1), showing the tank (2) the cooling flasks (3) the stoppers manifold (4), and the pouring receptacle (5).

FIG. 3 presents a sectioned side view of the apparatus (1), showing the gaps (6).

FIG. 4 depicts the way in which the pouring receptacle (5) is mounted on the stoppers manifold (4) that closes the cooling flasks (3).

FIG. 5 presents a sectioned top view of the cooling flasks (3), and the way in which they fit into the tank (2).

FIG. 6 is a sectioned side view of the tank (2) into which the flasks are inserted (3) and closed by the stoppers manifold (4), and of the way in which the pouring receptacle (5) closes the tank (2).

FIG. 7 is a schematic illustration of the gap (7) between two cooling flasks (3).

### THE INVENTION

The main objective of the present invention is to provide an apparatus (1) that enables to cool hot fluids within a relatively very short time. Another objective of the present invention is to provide an apparatus as mentioned that enables to cool liquids as mentioned while maintaining the sterility of the cooled liquids. For the sake of fluency of the text, the term “water” will refer to water as well as to a variety of other liquids, and the expression “boiled water” will also refer to hot water.

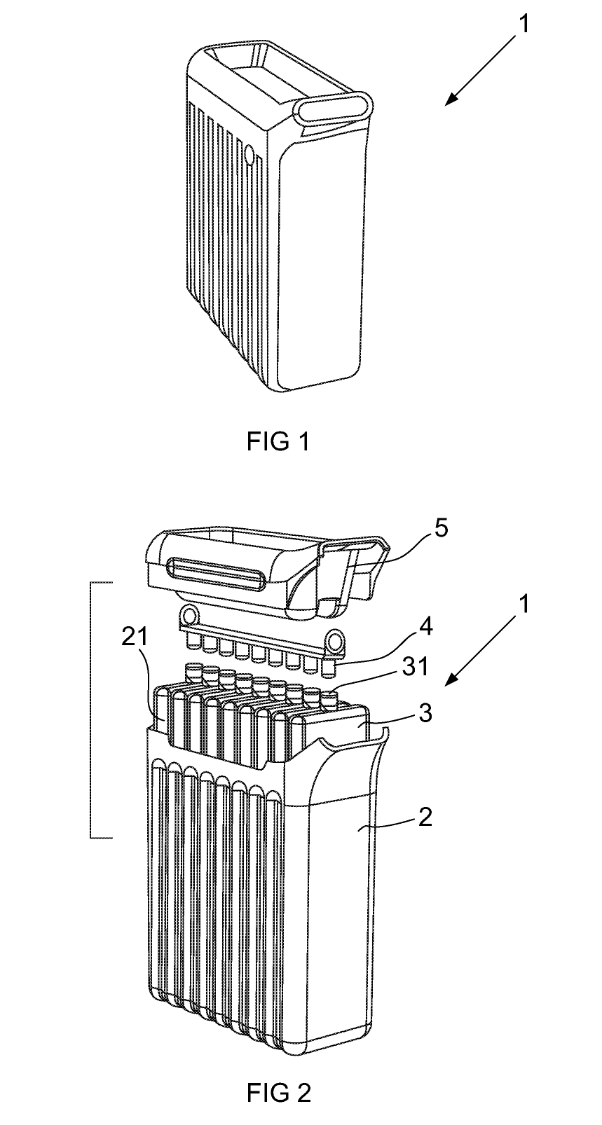

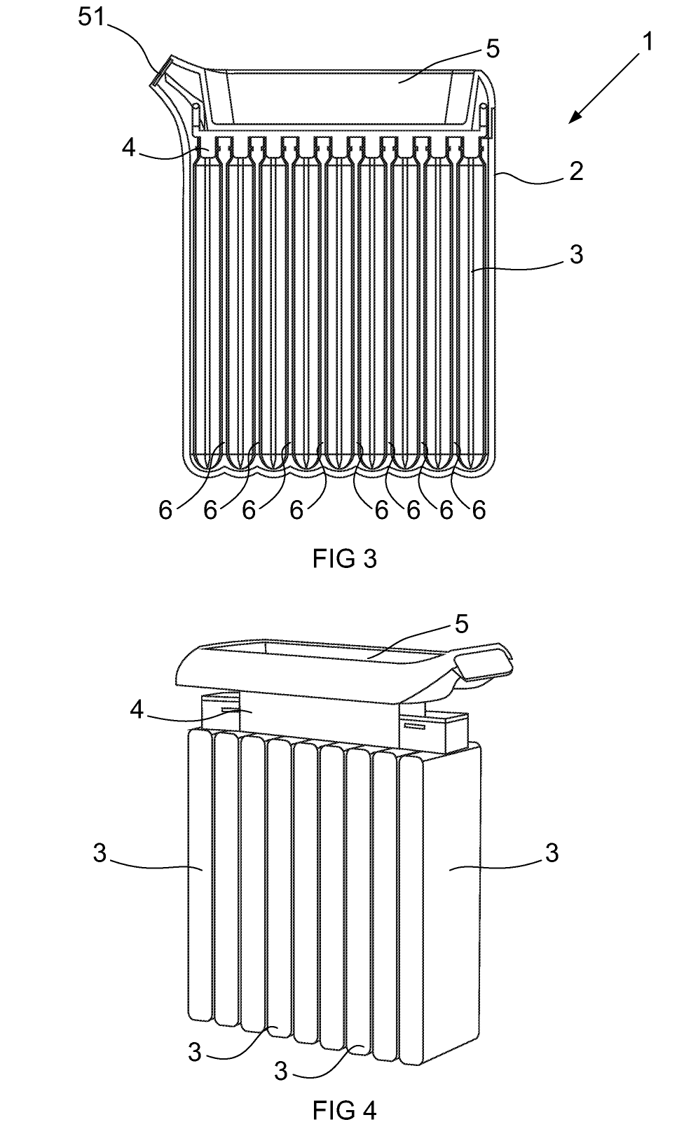

The apparatus for cooling hot water (1) consists of an external tank (2) and several internal cooling flasks (3). In addition, the apparatus (1) may include stoppers or a stoppers manifold (4) and a pouring receptacle (5). FIG. 1 depicts the apparatus (1) in its assembled state. FIG. 2 presents an exploded view of the apparatus (1) and the way in which its components are integrated. FIG. 3 presents a sectioned side view of the apparatus (1).

The tank (2) is closed on the bottom and on its circumferential sides, and has a top opening (21). The cooling flasks (3) are relatively narrow containers with a top opening (31). The apparatus (1) comprises several cooling flasks (3), at least three, positioned very close to one another within the external tank (2), as depicted, for instance, in FIGS. 2 and 3. The cooling flasks (3) should contain coolant, which can be either regular tap water or any other coolant.

The top openings (31) of the flasks (3) may be permanently closed after being filled with coolant. Alternatively, the openings (31) may be closed with stoppers (4) in a way that enables the user to fill and empty the coolant contents. Stoppers (4) may be individual such that each stopper closes one opening (31) or they can comprise a stoppers manifold (4) that closes all of the openings (31) at once, as depicted for example in the drawings. As mentioned, the apparatus (1) may be equipped with a pouring receptacle (5) that can be designed as a kind of basin with a bottom opening (51). The pouring receptacle may also serve as a top cover for the tank (2). In principle, the apparatus (1) does not have to be equipped with a pouring receptacle.

The gaps (7) between one cooling flask (3) and another constitute a fundamental element of the invention, subject of the present patent application. The cooling flasks (3) are set within the tank (2) in such a way that a very narrow gap (7) is left between each cooling flask (3) and the next cooling flask (3) adjacent to it. Thus, almost the entire volume of the tank (2) is occupied by the volume of the internal cooling flasks (3). FIGS. 2-5 illustrate the way in which the cooling flasks (3) can be positioned within the tank (2). The gap (7) between each two adjacent cooling flasks (3) is smaller than 2.5 millimeters, although the invention covers both larger and smaller dimensions as well.

The cooling space (6): Setting the cooling flasks (3) in the external tank (2) according to the aforementioned structure leaves very narrow spaces between the flasks (3). These narrow spaces constitute the cooling space (6). A variety of fixing means may be used (22) (33) to fix the cooling flasks (3) inside the external tank (2) so that very narrow gaps (7) exist between them, thus forming the cooling space (6).

The fixing means may be, for example, as depicted in the drawings, whereby the inner wall of the tank (2) has recesses (22) that match the lateral rounded side (33) of the flasks (3). The spaces between the flasks (3) create a single space that constitutes the cooling space (6), which may either be closed and have a top opening, or be completely open on top.

The internal cooling space (6) constitutes a space for quick and effective cooling, since its surface area is relatively very large. The structure of the cooling space (6) enables the coolant fluid in the cooling flasks (3) to quickly adsorb the heat. Thus, a relatively small volume of boiled water is poured into the cooling space, filling the very narrow gaps between the cooling flasks. The large contact area between the boiled water and the walls of the cooling flasks (3) leads to rapid cooling of the boiled water. After boiled water is poured into the apparatus (1), its temperature plummets to the desired temperature within a very short period of time.

Using the apparatus (1): If the apparatus (1) is equipped with stoppers (4) that enable the user to fill it with coolant such as tap water, and a pouring receptacle (5), as described above, then the apparatus (1) is used in the following way: the cooling flasks (3) are filled with tap water or another coolant, and are then closed with the stoppers (4). The tank (2) is then covered with the pouring receptacle (5). The boiled water is poured into the pouring receptacle (5) and flows into the internal cooling space (6). After a very short period of time, the water in the cooling space (6) may be poured out, simply by tilting the apparatus (1). The water that is cooled in the apparatus (1) is stationary during the cooling process and does not have to be circulated.

The structure of the apparatus components enables quick access to all component parts for quick and easy cleaning and disinfection, a very important aspect in the preparation of baby food. The apparatus components can be made from a wide variety of materials, even materials that are not especially good conductors of heat. For example, components may be manufactured from polypropylene, which meets strict standards with regard to food and beverage containers. The apparatus may come in a variety of sizes. For example, an apparatus designed for cooling boiled water used in the preparation of milk substitutes for babies may include an internal cooling space (6) with a volume in the order of 200 ml.

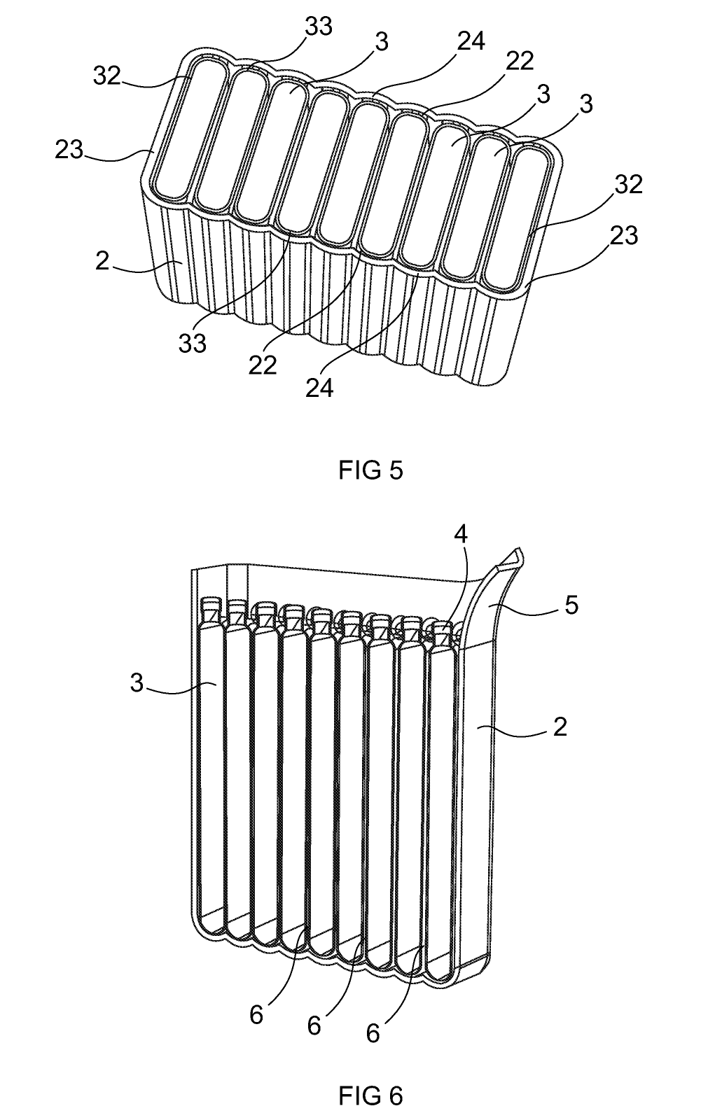

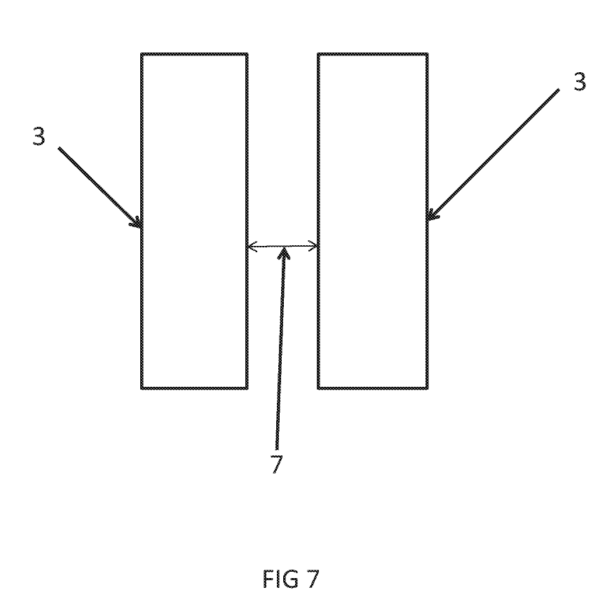

FIG. 1 depicts the cooling apparatus (1) in its closed state, ready for use. FIG. 2 presents an exploded view of the apparatus (1) that shows the tank (2), the flasks (3), the stoppers manifold (4) and the pouring receptacle (5), and the way in which they are integrated. FIG. 3 presents a sectioned side view of the apparatus (1) showing the cooling space (6). FIG. 4 depicts the way in which the pouring receptacle (5) is mounted on the stoppers manifold (4) that closes the cooling flasks (3). FIG. 5 presents a sectioned top view of the cooling flasks (3), and the way in which they fit into the tank (2). FIG. 6 is a sectioned side view of the tank (2) into which the flasks are inserted (3) and closed by the stoppers manifold (4), and of the way in which the pouring receptacle (5) closes the external tank (2). FIG. 7 is a schematic illustration of the gap (7) between two cooling flasks (3).

As it is understood from the above explanations and the drawings the apparatus (1) for cooling liquids comprises a tank (2) and cooling flasks (3). The tank (2) has two longitudinal walls (24), two lateral walls (23) and a top opening (21). Each cooling flasks has two longitudinal walls (32) and two lateral walls (33) and these cooling flasks are designed to contain coolant material.

The longitudinal wall (24) of the tank (2) has recesses (22) that match the shape of the lateral walls (33) of the cooling flasks (3). Each cooling flasks is designed to be fixed inside the tank by attaching the lateral walls of each cooling flasks to the recesses.

The cooling flasks are designed to be set within the tank in such a way that a gap (7) smaller than 2.5 millimeters is formed between each two adjacent cooling flasks, creating a cooling space (6). The total volume of the cooling flasks is three times greater or more than the total volume of the cooling space (6). For example, the best way is to have a proportion of 200 cc of cooling space and 800 cc total volumes of the cooling flasks. This structure enables the user to cool 200 cc of boiled water in a short time by using 800 cc of tap water (inside the cooling flasks). This structure enables the user to pour hot water into the cooling space (6) and the coolant material within the cooling flasks will adsorb heat from the hot water.

What is claimed is:

1. An apparatus for cooling liquids, comprising: a tank and cooling flasks;
wherein said tank has two longitudinal walls, two lateral walls and a top opening; wherein each of said cooling flasks has two longitudinal walls and two lateral walls; wherein said cooling flasks are designed to contain coolant material;
wherein each of said longitudinal wall of said tank has recesses wherein each of said recesses match a shape of said lateral walls of said cooling flasks; wherein each of said cooling flasks is designed to be fixed inside the tank by attaching the lateral walls of each cooling flasks to said recesses;
wherein the cooling flasks are designed to be set within the tank in such a way that a gap smaller than 2.5 millimeters is formed between each two adjacent cooling flasks, creating a cooling space; wherein a total volume of the cooling flasks is three times greater or more than a total volume of the cooling space; and
whereby enabling a user to pour hot water into said cooling space and a coolant material within said cooling flasks will adsorb heat from said hot water.
